(19) United States
(12) Patent Application Publication
(10) Pub. No.: US 2014/0295711 A1
(43) Pub. Date: Oct. 2, 2014

(54) CONNECTOR

(71) Applicants: John P. Franz, Houston, TX (US); Andrew James Phelan, Magnolia, TX (US); George D. Magason, Spring, TX (US); David A. Selvidge, Cypress, TX (US); Joseph R. Allen, Tomball, TX (US); Kelly K. Smith, Spring, TX (US); Michael S. Bunker, Tomball, TX (US)

(72) Inventors: John P. Franz, Houston, TX (US); Andrew James Phelan, Magnolia, TX (US); George D. Magason, Spring, TX (US); David A. Selvidge, Cypress, TX (US); Joseph R. Allen, Tomball, TX (US); Kelly K. Smith, Spring, TX (US); Michael S. Bunker, Tomball, TX (US)

(21) Appl. No.: 14/349,691

(22) PCT Filed: Oct. 25, 2011
(86) PCT No.: PCT/US2011/057634

§ 371 Date: Apr. 4, 2014

(51) Int. Cl. H01R 13/24

(52) U.S. Cl. CPC H01R 13/2428
USPC 439/660

(57) ABSTRACT

A compression connector includes a housing and a plurality of contacts located within the housing. Each of the plurality of contacts is configured to bend at a plurality of locations when pressure is applied to the contact. In addition, each of the plurality of contacts is configured to tuck within itself when pressure is applied to the contact. Furthermore, each of the plurality of contacts is constrained by the housing.

### BACKGROUND

Today's storage demands have created a need for systems that can store a massive amount of data. To this end, storage chassis have been developed to accommodate a plurality of drive assemblies. Each of the plurality of the drive assemblies is coupled to a backplane within the storage chassis, and each of the plurality of drive assemblies typically comprises a drive such as a hard disk drive (HDD) disposed within a drive carrier. The drive carrier is generally a mechanical device that serves to lock and hold the drive in a particular position within the storage chassis, and to protect the drive from electromagnetic energy interference (EMI) which may be caused by neighboring drives. The drive is generally a data storage device that stores and communicates data to/from a host device via the backplane. The drive is typically coupled to the backplane via a standard SAS (serial attached small computer system interface), SATA (serial advanced technology attachment) data connector, or SCSI (small computer system interface) connector.

### BRIEF DESCRIPTION OF THE DRAWINGS

Example embodiments are described in the following detailed description and in reference to the drawings, in which:

FIG. 1 is a graphical representation of a system in accordance with embodiments;

FIG. 2 is a graphical representation of a substrate assembly in accordance with embodiments;

FIG. 3 is a graphical representation of how the substrate assembly may be affixed to a drive carrier in accordance with embodiments;

FIG. 4 is a graphical representation of a backplane with a first connector and a second connector in accordance with embodiments;

FIG. 5 is a graphical representation depicting the manner in which a drive assembly couples to a backplane in accordance with embodiments;

FIG. 6 is a close-up view of a compression connector in accordance with embodiments;

FIG. 7 is a close-up tilted view of a contact without a surrounding housing in accordance with embodiments;

FIG. 8 is a close-up side view of a contact without a surrounding housing in accordance with embodiments;

FIG. 9(a) is a tilted view of the top of a compression connector in accordance with embodiments;

FIG. 9(b) is a side view of a compression connector in accordance with embodiments;

FIG. 9(c) is another side view of a compression connector in accordance with embodiments;

FIG. 9(d) is still another side view of a compression connector in accordance with embodiments;

FIG. 9(e) is a bottom view of a compression connector in accordance with embodiments;

FIG. 9(f) is a top view of a compression connector in accordance with embodiments; and

FIG. 10 is a graphical view of a compression connector integrated into a right angle connector in accordance with embodiments.

### DETAILED DESCRIPTION

Typical drive carriers are mechanical enclosures that surround and protect all or a portion of a hard drive. These mechanical enclosures generally comprise no electrical components and, at best, may include a light pipe to communicate light originating from a light source on the backplane to the drive carrier bezel. The light from the light source usually appears as a small illuminated circle on the drive carrier bezel and conveys a minimal amount of information due to the limited number of light source illumination combinations. Accordingly, typical drive carriers are simple mechanical chassis that have limited functionality outside of their mechanical attributes.

Various embodiments described herein are directed to a compression connector configured to couple to an advanced drive carrier. More precisely, various embodiments are directed to a compression connector that enables electrical signaling between a computing device located on a substrate integrated within an advanced drive carrier and a backplane. The signaling is separate and distinct from the standard signaling between the backplane and the hard drive (e.g., via a SAS/SATA/SCSI connector), insofar as the signaling is via a separate communication channel, via a separate connector, and to a different target (i.e., the signaling is to a computing device on a drive carrier, as opposed to a drive within the drive assembly).

The use of a separate communication channel and a separate connector may enable advanced drive carrier functionality. For example, the drive carrier via its integrated computing device and via the above-mentioned new signaling channel and compression connector may provide previously unforeseen functions such as drive carrier authentication, drive carrier error logging, drive carrier light source controlling, drive carrier touch sensing, and/or drive carrier distributed backplane management. The compression connector may be located on the backplane next to the standard connector (e.g., a SAS/SATA/SCSI connector) and may make contact with pads on the drive carrier substrate when the drive assembly is inserted into the storage chassis.

In some embodiments, the compression connector comprises a housing and a plurality of contacts located within the housing. Each of the plurality of contacts is configured to bend at a plurality of locations when pressure is applied to the contact. In addition, each of the plurality of contacts is configured to tuck within itself when pressure is applied to the contact. Furthermore, each of the plurality of contacts is constrained by the housing.

In further embodiments, a backplane comprises a first connector to connect to a drive of a drive assembly, and a second connector to connect to a drive carrier of the drive assembly. The second connector comprises a housing and a plurality of contacts located within the housing. Each of the plurality of contacts is configured to bend at a plurality of locations when pressure is applied to the contact. In addition, each of the plurality of contacts is configured to tuck within itself when pressure is applied to the contact. Furthermore, each of the plurality of contacts is constrained by the housing.

In still further embodiments, a system comprises a drive assembly comprising a drive and a drive carrier, and a backplane comprising a first connector to connect to the drive and a second connector to connect to the drive carrier. The second connector comprises a housing and a plurality of contacts located within the housing. Each of the plurality of contacts is configured to bend at a plurality of locations when pressure is applied to the contact. In addition, each of the plurality of contacts is configured to tuck within itself when pressure is applied to the contact. Furthermore, each of the plurality of contacts is constrained by the housing.

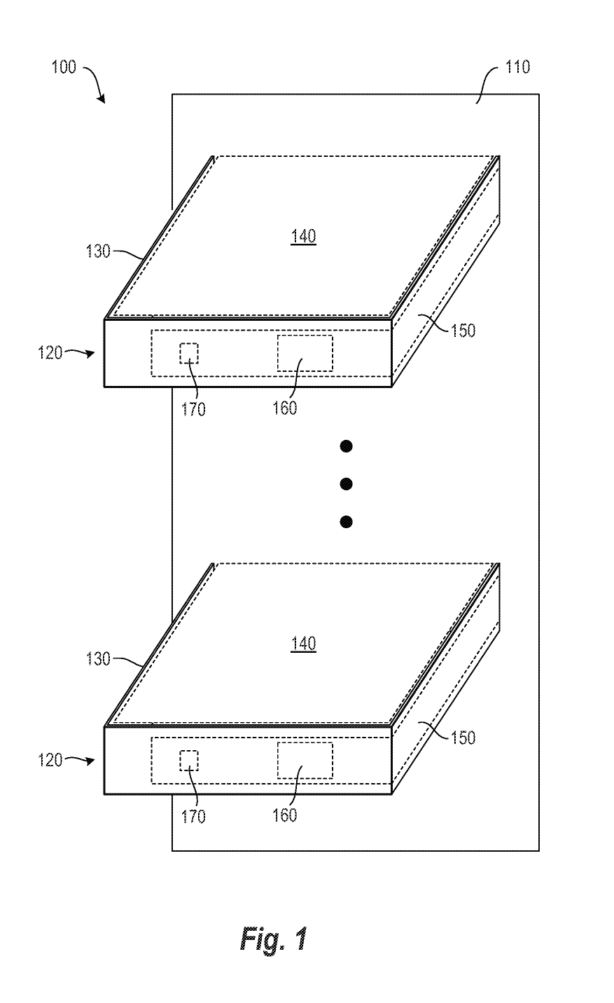

FIG. 1 is a block diagram of a system in accordance with embodiments. The system 100 comprises a backplane 110 and a plurality of hot-pluggable drive assemblies 120 coupled to the backplane 110. The system may be located within a storage chassis, cage, disk enclosure, disk array, and/or server. Each drive assembly 120 may comprise a drive carrier 130 and a drive 140 disposed within the drive carrier 130. The drive 140 may be, for example, a hard disk drive (HDD), a solid state drive (SSD), or a hybrid drive. The HDD may use spinning disks and movable read/write heads. The SSD may use solid state memory to store persistent data, and use microchips to retain data in non-volatile memory chips. The hybrid drive may combine features of the HDD and SSD into one unit containing a large HDD with a smaller SSD cache to improve performance of frequently accessed files. Other types of drives such as flash-based SSDs, enterprise flash drives (EFDs), and the like may also be used with the drive carrier 130.

Each drive carrier 130 may comprise a substrate 150, a computing device 160 located on the substrate 150, and/or a light source 170 located on the substrate 150. The drive carrier 130 may be constructed of plastic, metal, and/or other materials. The drive carrier 130 may include a front plate or bezel, opposing sidewalls, and a floor. A drive 140, such as a HDD. SSD, or hybrid drive, may be placed within and/or attached to the area formed by the opposing sidewalls, the floor, and the front plate.

The substrate 150 may be attached or otherwise integrated into the drive carrier 130. In embodiments, the substrate 150 may comprise flexible and/or rigid material. For example, the substrate 150 may be a flexible circuit board, a rigid circuit board, or a combination of both. In some embodiments, the substrate 150 may comprise a flexible circuit board wherein a portion is attached to a backer board or a stiffening support carrier. The backer board or stiffening support carrier may be used, for example, in the bezel portion of the drive carrier to provide additional support for components placed thereon, or in the rear portion of the drive carrier to enable a solid and reliable connection with a bracket. The substrate 150 may include contact pads such as gold contact pads. The substrate 150 may be single-sided, double-sided, single-sided dual access (S2), single-layer, and/or multi-layer. The substrate 150 may accommodate surface mounted devices and/or through-hole devices.

The computing device 160 may be, for example, a microcontroller, a microprocessor, a processor, a CPLD, an ASIC, or another similar computing device. The computing device 160 may be configured, via instructions stored thereon, to conduct various functions. For example, the computing device 160 may control light source 170. Light source 170 may be, for example, a light emitting device (LED), an incandescent light source, a fluorescent light source, a neon light source, and/or any other type of light source. In some embodiments, the light source 170 may comprise a plurality of light sources. The computing device 160 may drive the light source(s) via signals received from a host device (e.g., an array controller, a host bus adapter (HBA), an expander, and/or a server), signals received from the hard drive associated with the drive carrier, and/or based on conditions sensed by internal or external sensors (e.g., a temperature sensor, a vibration sensor, a touch sensor, an airflow sensor, a humidity sensor, etc.). In some embodiments, the computing device 160 may drive the light source(s) to illuminate an air flow area, to illuminate a do not remove drive indication, and/or to illuminate a self-describing animated image. The computing device 160 may be further configured, via instructions stored thereon, to conduct drive carrier authentication operations and/or to store error information.

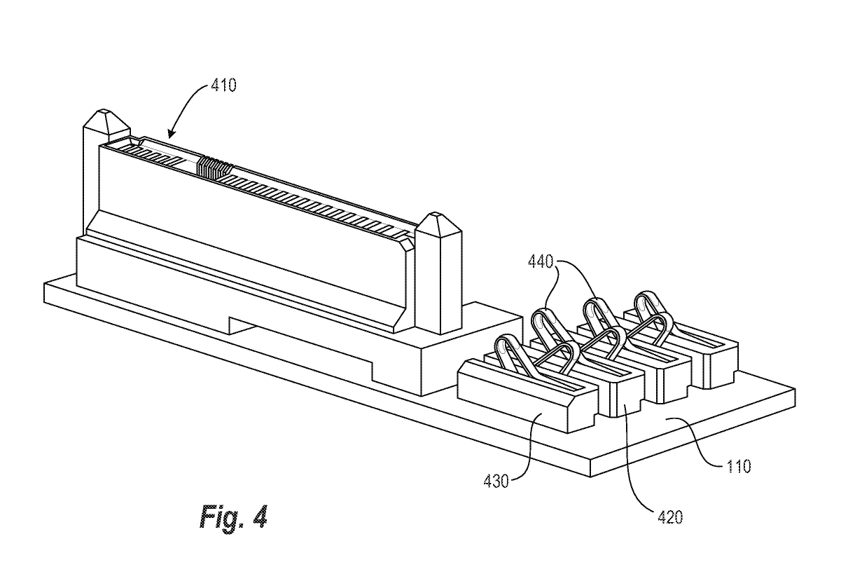

As discussed in further detail below, the backplane 110 may couple to each drive assembly 120 via at least two connectors (shown in FIG. 4). The first connector may be a standard connector (e.g., a SAS/SATA/SCSI connector) to communicate read/write and other data between the backplane 110 and the drive 140. The second connector may be a custom compression connector to communicate data between the backplane 110 and the above-mentioned computing device 160 on the substrate 150 within the drive carrier 130. A host device, such as an array controller, a host bus adapter (HBA), an expander, and/or. a server, may communicate with the drive 140 and/or computing device 160 via the first and second connectors.

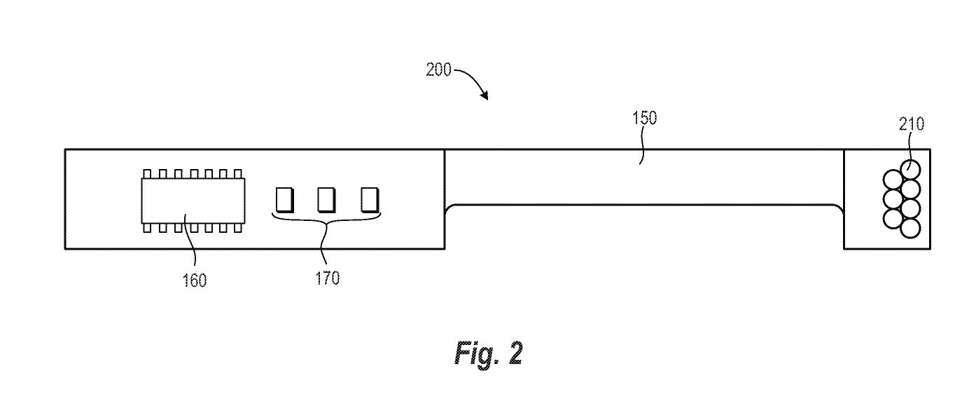

FIG. 2 is a graphical representation of a substrate assembly 200 in accordance with embodiments. In particular, FIG. 2 depicts a substrate 150 with a computing device 160, a plurality of light sources 170, and a plurality of contact pads 210 located thereon. The substrate 150 may be formed of flexible material (e.g., flexible circuit board), rigid material (e.g., rigid circuit board), or a combination of both materials. The substrate 150 may extend from the rear of the drive carrier 130 to the bezel of the drive carrier 130. The portion of the substrate assembly with the computing device 160 and light sources 170 may be located proximate to the bezel of the drive carrier in accordance with embodiments. The substrate assembly 200 may be affixed to the rear of the drive carrier 130 via a bracket, where the bracket is formed of sheet metal and comprises a plurality of bent flanges that secure the substrate 150 into the bracket.

A plurality of contact pads 210 on the substrate 150 may couple to a compression connector on the backplane, and therefore enable signaling between the computing device 160 and the backplane 110 and/or host device. In particular, the plurality of contact pads 210 may be situated in two rows in a staggered configuration, where the pads of one row are aligned between the pads of the other row. The plurality of contact pads 210 may connect to a plurality of traces to communicate a plurality of signals bi-directionally between the pads 210 and the computing device 160. Such signals may include, for example, signals to set the drive carrier address and bay number, signals to indicate hard drive activity, signals to provide power and ground, signals to provide data, signals to set a drive carrier box number and alert a host of a status change, and/or signals for clocking.

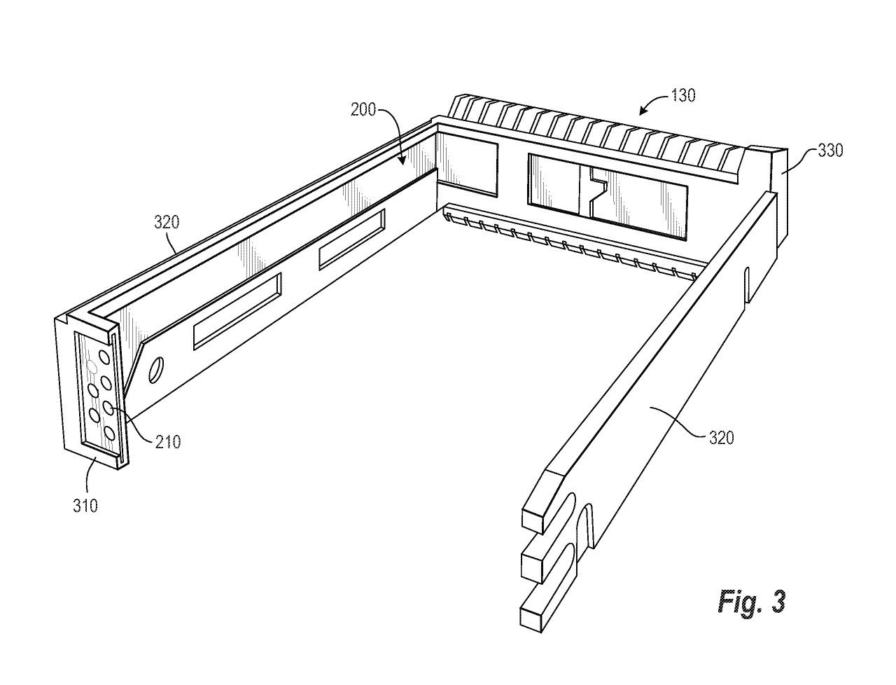

FIG. 3 is a graphical representation of how the substrate assembly 200 of FIG. 2 may be affixed to the drive carrier 130 in accordance with embodiments. As shown, the substrate assembly 200 may be coupled to the rear of the drive carrier 310, one of the opposing sidewalls 320, and the front of the drive carrier 330. The substrate may be formed of flexible material, rigid material, or a combination of both. For example, the portion of the substrate at the rear of the drive carrier 310 and the front of the drive carrier 330 may be rigid, and the portion on the sidewall 320 may be flexible. In some embodiments, the substrate may be a flexible circuit board and a stiffening support or backer board may be located behind portions of the flexible substrate to provide support. This arrangement may be used, for example, in the rear portion 310 and front portion 330 of the drive carrier. In some embodiments, the substrate may comprise a combination of rigid circuit board and flexible circuit board in a single continuous piece. In other embodiments, one or more substrates may be communicatively coupled via cabling to one another.

The substrate assembly 310 may be inserted into a bracket located at a rear portion of the drive carrier 310. This bracket may hold the substrate assembly 200 in place and enable an electrical connection to be made between the plurality of contact pads 210 and a compression connector located on the backplane and discussed in greater detail below. Via this connection, electrical signals may be passed from the backplane 110 to the computing device 160.

FIG. 4 is a graphical representation of a backplane 200 with a first connector 410 and a second connector 420 (i.e., the compression connector) in accordance with embodiments. As discussed above, the first connector 410 may be a standard hard drive connector (e.g., a SAS/SATA/SCSI connector). For example, the first connector 410 may be a multi-position SAS receptacle that enables the implementation of high-speed, SAS hard disk drive HDD interfacing. The first connector 410 may be designed to support hot plugging and blind mating of HDDs. The first connector 410 may couple with the drive 140 of the drive assembly 120. A connector corresponding to the first connector 410 may be located on the drive 140. For example, a plug connector may be located on the drive 140 to couple with the first connector 410 on the backplane 110.

The second connector 420 (i.e., the compression connector) may be positioned proximate and/or adjacent to the first connector 410 on the backplane 110. The second connector 420 may be arranged to make contact with a plurality of pads 210 on the substrate 150 integrated within the drive carrier 130. The second connector 420 may be a compression-type connector. More precisely, compression may be applied to the second connector 420 when a drive assembly 120 is inserted into a storage chassis and attached to the backplane 110. While in the compressed state, the second connector 420 may communicatively couple with the plurality of pads 210 on the substrate 150.

The second connector 420 may comprise a housing 430 and a plurality of contacts 440 disposed therein. The housing may be formed of plastic 430 or other suitable material. The contacts may be formed of metal or other conductive material. When in the un-compressed or “free state,” the plurality of contacts 440 may protrude vertically from the housing 430. When in the compressed state, the plurality of contacts 440 may lower into the housing 430. The housing 420 may guide each of the plurality of contacts 440 from the free state to the compressed state when pressure is applied to the contact to prevent twisting or damage. At least one of the plurality of contacts 440 may be vertically taller than the other of the plurality of contacts 440 when the plurality of contacts 440 are in a free state to enable sequential connection. The plurality of contacts 440 may be surface mounted, through-hole mounted, or press-fit mounted to the backplane 110.

In embodiments, the plurality of contacts 440 may be mirrored in opposite directions and/or in an alternating pattern across a centerline. That is, each of the plurality of contacts 440 may be oriented in an opposite direction of an adjacent contact. This arrangement may be beneficial to balance the deflection force when the second connector 420 is compressed. Moreover, this arrangement may be beneficial to provide space for the housing 420 to support each contact 440. Further, this arrangement may leave additional space for each of the plurality of contacts 440 to mount to the backplane, and thereby enable larger routing paths.

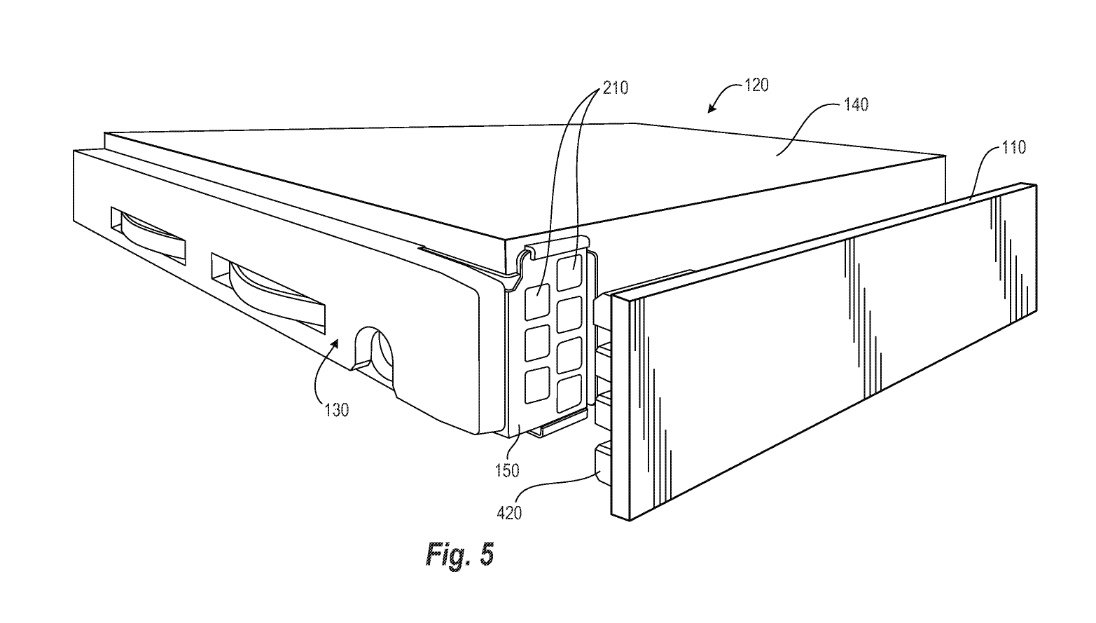

FIG. 5 is a graphical representation depicting the manner in which the drive assembly 120 may couple to the backplane 110 in accordance with embodiments. More specifically, FIG. 5 depicts how the second connector 420 on the backplane 110 (i.e., the compression connector) couples with the substrate 150 and associated contact pads 210 on the rear of the drive carrier 130. As shown, the plurality of contacts 440 on the second connector 420 of the backplane 110 align with the plurality of pads 210 on the substrate 150 on the rear of the drive carrier 130. In embodiments, the plurality of pads 210 the may be situated in two rows and in a staggered configuration, where the pads of one row are aligned in-between the pads of the other row. Due to the plurality of contacts 440 being in an alternating and mirrored configuration, the plurality of pads 210 and the plurality of contacts 440 may align to form an electrical connection. In some embodiments, the plurality of pads 210 may be substantially larger than the tip of each of the plurality of contacts 440 to provide a large target and large tolerance range to account for potential shifting of components of the drive assembly 120 or backplane 110.

The first connector 410 (shown in FIG. 4) may be located adjacent and/or proximate to the second connector 420. The first connector 410 may couple with the drive 140 of the drive assembly 120. A connector corresponding to the first connector 410 may be located on the drive 140. For example, a plug connector may be located on the drive 140 to couple with a receptacle of the first connector 410 on the backplane 110.

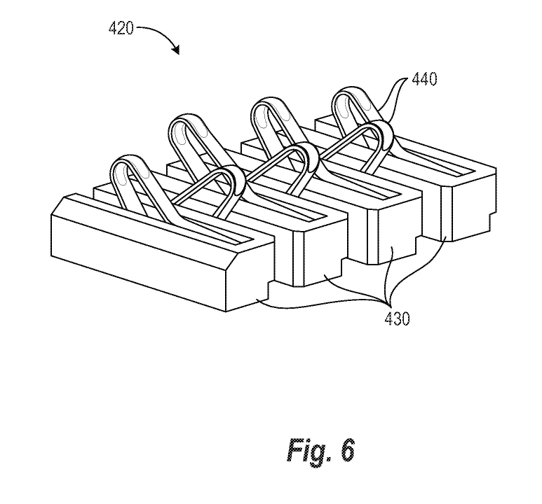

FIG. 6 is a close-up view of the compression connector 420 in accordance with embodiments. As shown, each of the plurality of contacts 440 may be substantially enclosed on three sides by the housing 430. That is, the housing 430 may form a partial rectangle around each of the plurality of contacts 440. The housing 430 may be a continuous piece of material where each of the plurality of contacts 440 is within the same continuous piece of material. The plurality of contacts 440 may protrude vertically from the housing 430 when the compression connector 420 is in a free state. The upper portion of each of the plurality of contacts 440, which is intended to make contact with the contact pads 210 on the substrate 200 of the drive carrier 130, may be rounded and/or have a raised rounded bump. By including this rounded area, damage may be prevented to the contact pad 210 on the substrate 200 upon contact. Further, this rounded area may prevent the plurality of contacts 440 from snagging onto objects and thereby damaging the contact 440 during handling.

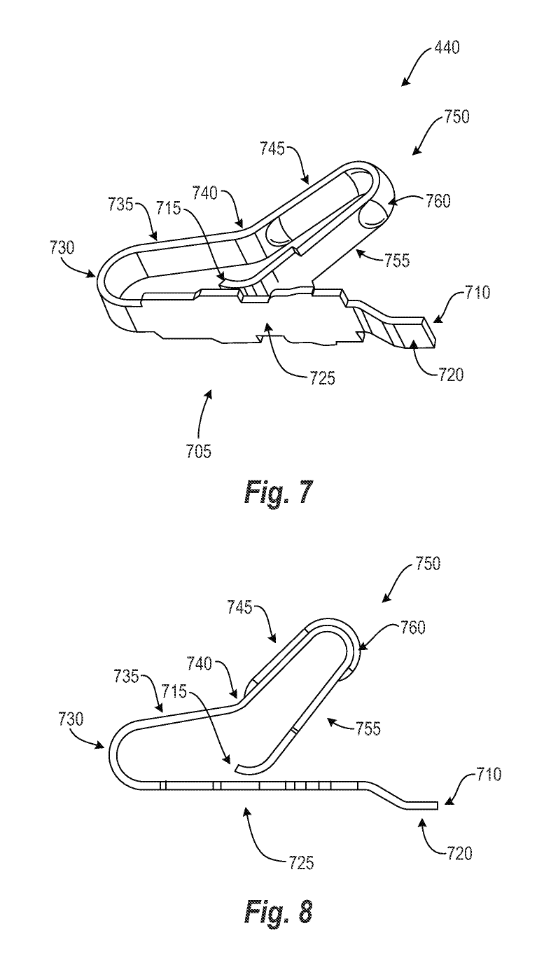

FIG. 7 is a close-up tilted view of one of the plurality of contacts 440 without the surrounding housing 430 in accordance with embodiments. The contact may be formed of a single piece of material and comprise a first tip 710 and second tip 715. Both of these tips (710 and 715) may be constrained by the housing when the contact is in a free state and also when pressure is applied to the contact. Put another way, the tips (710 and 715) are situated at a low vertical position within the housing and neither of these tips (710 and 715) protrude outside of the housing in the vertical direction in either the free state or the compressed state.

Beginning a detailed description of the contact from the bottom side 705 and the first tip 710, the contact includes a mounting portion 720. The mounting portion 720 may include a flat portion to enable the mounting portion to be surface mounted to a pad on the backplane 110. The mounting portion 720 may be situated slightly lower in the vertical direction than the bottom portion 725 of the contact. The bottom portion 725 may be flat and may lead into the first bend point 730. This first bend point 730 may be in the approximate shape of a half-circle. When pressure is applied to the contact, the first bend point 730 may bend or flex causing to the contact to reduce in the vertical direction. That is, the diameter of the approximate semi-circle may appear to decrease when pressure is applied to the contact. Continuing in the direction from the first bend point 730 is a slightly angled portion 735 followed by a second bend point 740. The second bend point may join the slightly angled portion 735 and a substantially angled portion 745. When pressure is applied to the contact, the second bend point 740 may appear to further open due to the pressure and the slightly angled portion 735 and the substantially angled portion 745 may move closer to a parallel alignment.

Following the substantially angled portion 745 is a third bend portion 750. The third bend portion 750 may make contact with the contact pad 210 on the substrate 200 of the drive carrier when a drive assembly is inserted into a storage chassis. Pressure from the insertion may cause the third bend portion 750 to bend or flex in the vertical direction. Similar to the first bend point 730, the diameter of the approximate semi-circle of the third bend point 750 may appear to decrease when pressure is applied to the contact. Beneath the third bend point 750 is tuck portion 755. Tuck portion 755 leads to the second tip 715 or lip.

As pressure is applied to the compression connector, the tuck portion 755 and second tip 715 tuck or fold into the contact. The greater the amount of pressure applied, the further the tuck portion 755 and second tip 715 tuck or fold into the contact. In some instances, the tuck portion 755 and/or area proximate to the second tip 715 may make contact with the bottom portion 725 when pressure is applied. Furthermore, in some instances, the area proximate to the second tip 715 may tuck-in and vertically raise in the direction of the slightly angled portion 735 when pressure is applied to the contact.

In embodiments, the area proximate to the third bend portion 750 may be rounded. That is, the portion may have a raised dome-shape 760 in comparison to the other portions of the contact which may be substantially flat. By including this rounded area 760, damage may be prevented to the contact pad 210 on the substrate 200 upon contact. Further, this rounded area 760 may prevent the contact from snagging onto an object and damaging the contact during handling.

FIG. 8 is a close-up side view of one of the plurality of contacts 440 without the surrounding housing 430 in accordance with embodiments. As is more visible from this view, a portion beginning near the second bend point 740 and continuing over the third bend point 750 and to the tuck portion 755 may be raised, rounded, and/or smooth. This rounded design may protect the portion of the contact protruding from the housing from damage, and may further protect the contact pads on the substrate of the drive carrier from damage when contact is made between the compression connector and the drive carrier.

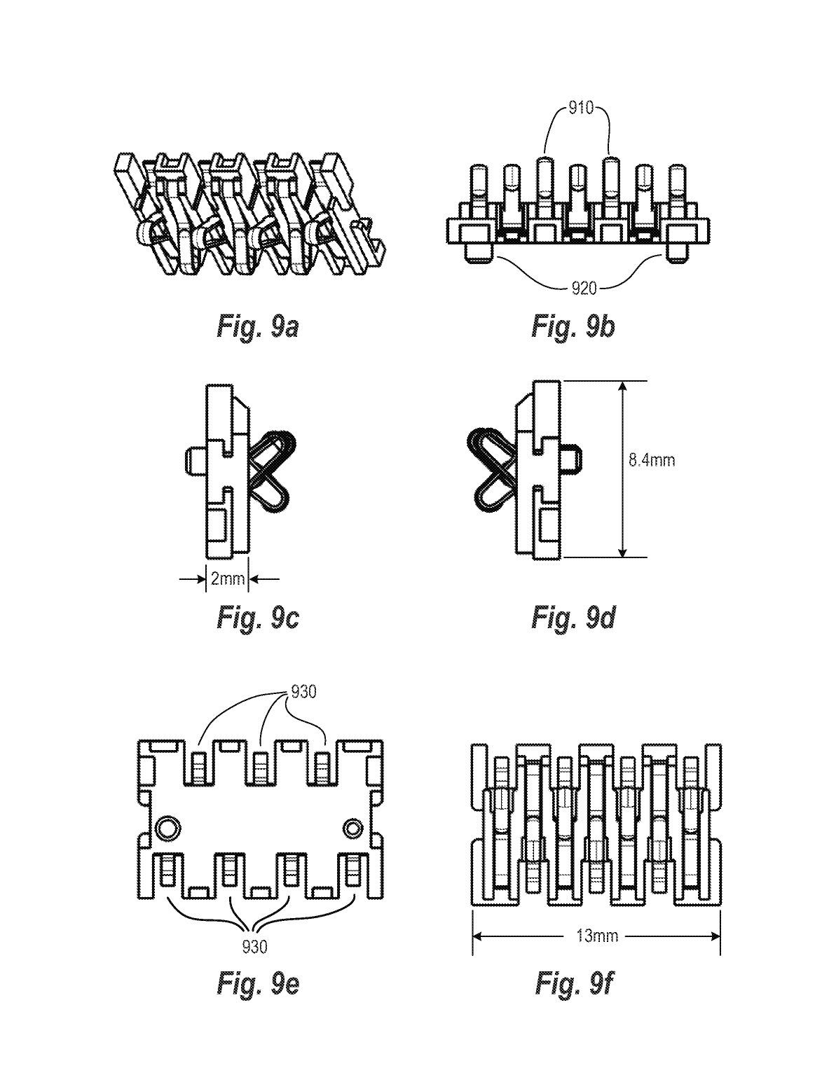

FIG. 9(a) is a tilted view of the top of the compression connector 420 in accordance with embodiments. In particular, FIG. 9(a) depicts the side of the compression connector 420 intended to make contact with the contact pads 210 on the substrate 200 of the drive carrier. As shown, the contacts 440 may be in an alternating pattern with adjacent contacts facing in opposite directions in accordance with embodiments. In alternative embodiments, all contacts 440 may face the same direction. Additionally, in some embodiments, a few adjacent contacts may face one direction, while other contacts may face an opposing direction.

FIG. 9(b) is a side view of the compression connector 420 in accordance with embodiments. As shown, one or more contacts 910 may be taller than the other contacts. This arrangement may enable sequential contact with the contact pads 210 on the substrate 200 of the drive carrier, where the taller contacts may make contact with the contact pads 210 first and break contact last (i.e., first mate, last break connection). In some embodiments, the taller contact(s) may be used to provide power and/or ground signals.

At the bottom of the compression connector 420 may be two posts 920. These posts 920 may be used to attach and secure the compression connector to the backplane 110 or another component.

FIG. 9(c) is another side view of the compression connector 420 in accordance with embodiments. As shown, the width dimension of the compression connector may be approximately 2 mm in accordance with embodiments. This dimension should not be seen as limiting, however, because larger or smaller dimensions may be used in accordance with other embodiments.

FIG. 9(d) is still another side view of the compression connector 420 in accordance with embodiments. As shown, the height dimension of the compression connector may be approximately 8.4 mm in accordance with embodiments. However, this dimension should not be seen as limiting, as larger or smaller dimensions may be used in accordance with other embodiments.

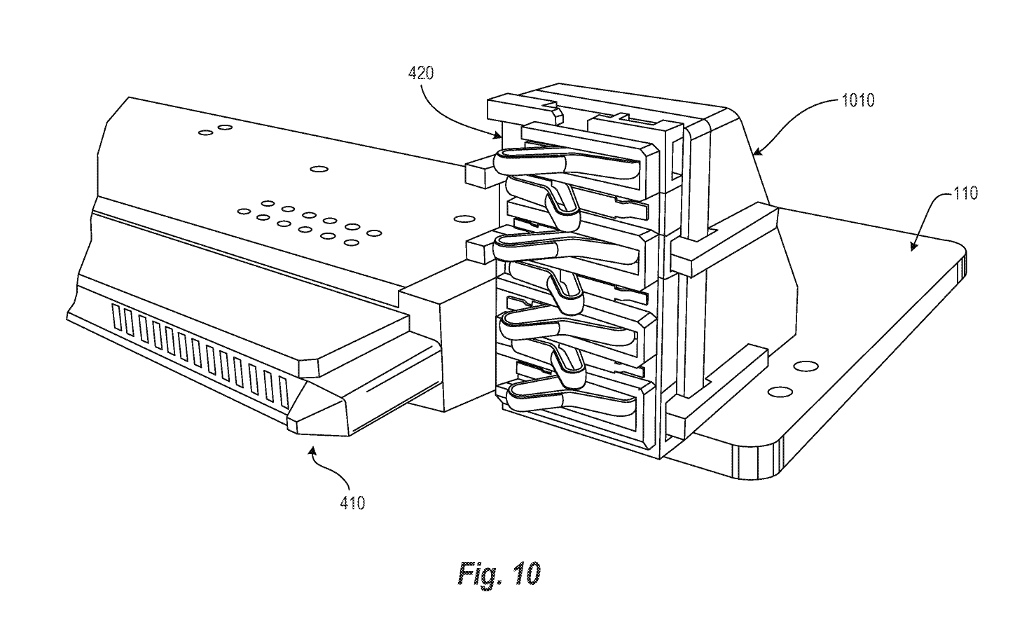

FIG. 9(e) is a bottom view of the compression connector 420 in accordance with embodiments. As shown, a surface mount portion 930 of each contact may protrude from the housing. This surface mount portion 930 may be coupled to a surface mount pad on the backplane 110 using surface mount techniques in accordance with embodiments. In alternate embodiments, the compression connector 420 may be press-set mounted or through-hole mounted to the backplane 110. In further embodiments, the compression connector 420 may be mounted to a connector using one of the above-mentioned mounting techniques, and that connector may be mounted to the backplane 110 (see, e.g., FIG. 10).

FIG. 9(f) is a top view of the compression connector 420 in accordance with embodiments. As shown, the length dimension of the compression connector may be approximately 13 mm in accordance with embodiments. This dimension should not be seen as limiting, however, because larger or smaller dimensions may be used in accordance with other embodiments.

FIG. 10 is a graphical view of the compression connector integrated into a right angle connector in accordance with embodiments. In particular, FIG. 10 depicts the compression connector 420 referenced in FIG. 4 and FIGS. 6-9 mounted to a right angle connector 1010. The right angle connector 1010 is mounted to the backplane 110. In particular, the right angle connector 1010 is mounted to the backplane 110 in a position proximate and adjacent to the above-referenced first connector 410. This right angle solution may be appropriate for different backplane, drive assembly 120, drive 140, and/or drive carrier 130 designs.

What is claimed is:

1. A compression connector, comprising:
a housing; and
a plurality of contacts located within the housing,
wherein each of the plurality of contacts is to bend at a plurality of locations when pressure is applied to the contact,
wherein each of the plurality of contacts is to tuck within itself when pressure is applied to the contact, and
wherein each of the plurality of contacts is constrained by the housing.

2. The compression connector of claim 1, wherein the plurality of contacts are mirrored in opposite directions and in an alternating pattern across a centerline.

3. The compression connector of claim 1, wherein a portion of each of the plurality of contacts is to be surface mounted to a backplane.

4. The compression connector of claim 1, wherein a rounded portion on each of the plurality of contacts is to make contact with a pad on a drive carrier substrate.

5. The compression connector of claim 1, wherein a first tip and a second tip of each of the plurality of contacts are constrained by the housing when the contact is in a free state and also when pressure is applied to the contact.

6. The compression connector of claim 1, wherein the housing guides each of the plurality of contacts from a free state to a compressed state when pressure is applied to the contact.

7. The compression connector of claim 1, wherein at least one of the plurality of contacts is vertically taller than the other of the plurality of contacts when the plurality of contacts are in a free state.

8. The compression connector of claim 1, wherein each of the plurality of contacts is oriented in an opposite direction of an adjacent contact.

9. A backplane comprising:
a first connector to connect to a drive of a drive assembly; and
a second connector to connect to a drive carrier of the drive assembly, wherein the second connector comprises
a housing; and
a plurality of contacts located within the housing,
wherein each of the plurality of contacts is to bend at a plurality of locations when pressure is applied to the contact,
wherein each of the plurality of contacts is to tuck within itself when pressure is applied to the contact, and
wherein each of the plurality of contacts is constrained by the housing.

10. The backplane of claim 9, wherein the first connector is a serial attached small computer system interface (SAS) connector or a serial advanced technology attachment (SATA) connector.

11. The backplane of claim 9, wherein the plurality of contacts are mirrored in opposite directions and in an alternating pattern across a centerline.

12. The backplane of claim 9, wherein a rounded portion on each of the plurality of contacts is to make contact with the drive carrier.

13. The backplane of claim 9, wherein the housing guides each of the plurality of contacts from a free state to a compressed state when pressure is applied to the contact.

14. The backplane of claim 9, wherein a first tip and a second tip of each of the plurality of contacts are constrained by the housing when the contact is in a free state and also when pressure is applied to the contact.

15. A system comprising:
a drive assembly comprising a drive and a drive carrier; and
a backplane comprising a first connector to connect to the drive and a second connector to connect to the drive carrier, wherein the second connector comprises
a housing; and
a plurality of contacts located within the housing,
wherein each of the plurality of contacts is to bend at a plurality of locations when pressure is applied to the contact,
wherein each of the plurality of contacts is to tuck within itself when pressure is applied to the contact, and
wherein each of the plurality of contacts is constrained by the housing.
